(19) United States
(12) Patent Application Publication
(10) Pub. No.: US 2009/0068525 A1
(43) Pub. Date: Mar. 12, 2009

(54) Fuel Cell Electrode, Method for Producing Fuel Cell Electrode, Membrane-Electrode Assembly, Method for Producing Membrane-Electrode Assembly, and Solid Polymer Fuel Cell

(76) Inventor: Hirofumi Iisaka, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/226,906

(22) PCT Filed: May 23, 2007
(86) PCT No.: PCT/JP2007/060938

§ 371 Date: Oct. 31, 2008

(30) Foreign Application Priority Data
May 23, 2006 (JP) 2006-142872

(51) Int. Cl. H01M 8/10

(52) U.S. Cl. 429/30; 427/115

(57) ABSTRACT

With the use of a fuel cell electrode in which a binder layer (buffer layer) containing a thickening agent is provided on a gas diffusion layer and an electrode catalyst layer containing catalyst particles and a polymer electrolyte is laminated on the binder layer (buffer layer), it is possible to provide: a fuel cell electrode in which the adhesivity between a gas diffusion layer made of carbon paper or carbon cloth and an electrode catalyst layer containing catalyst particles and a polymer electrolyte is improved and delamination of or crack generation in an electrode catalyst layer does not occur; a membrane-electrode assembly (MEA) comprising the fuel cell electrode; and a solid polymer fuel cell comprising the membrane-electrode assembly.

### TECHNICAL FIELD

The present invention relates to a fuel cell electrode, a method for producing a fuel cell electrode, a membrane-electrode assembly in which a proton exchange membrane, an electrode catalyst layer, and a gas diffusion layer are laminated, a method for producing a membrane-electrode assembly, a membrane-electrode assembly, and a solid polymer fuel cell comprising the membrane-electrode assembly.

### BACKGROUND ART

Solid polymer fuel cells are characterized in that they have low operating temperatures and short startup times, allow high output to be easily obtained, are expected to be reduced in size and weight, and are resistant to vibration. Thus, solid polymer fuel cells are suitable as power sources for mobile objects.

A solid polymer electrolyte is a polymer material comprising a polymer chain having electrolyte groups such as a sulfonic group. It has the characteristics of strongly binding to a specific ion and selectively allowing permeation by cations or anions. In particular, a fluoride group electrolyte membrane represented by a perfluorosulfonic acid membrane has very high chemical stability, and thus it is widely applied as an ion-exchange membrane used for fuel cells that are used under extreme conditions.

In a solid polymer fuel cell, a pair of electrodes are provided to both sides of an ion-exchange membrane having proton conductivity, hydrogen gas is supplied as a fuel gas to one electrode (fuel electrode), and oxygen gas or air is supplied as an oxidant to the other electrode (air electrode), such that electromotive force is obtained.

When such ion-exchange membrane is applied in a solid polymer fuel cell, a membrane-electrode assembly is used, which has a structure such that electrode catalyst layers having fuel oxidizing capacity or oxidant reducing capacity are disposed on both sides of the ion-exchange membrane, on the outside of which gas diffusion layers are further disposed.

Specifically, the structure includes an ion-exchange membrane consisting of a polymer electrolyte membrane that selectively transports hydrogen ions, on each side of which an electrode catalyst layer comprising, as a main component, a carbon powder supporting a platinum group metal catalyst is formed. Next, on the outer surface of the electrode catalyst layer, a gas diffusion layer, which has both fuel gas permeability and electron conductivity, is formed. In general, a gas diffusion layer consists of a substrate of carbon paper or carbon cloth on which a film of a paste containing a powder of fluorine resin, silicon, carbon or the like is formed. The aforementioned electrode catalyst layer and the gas diffusion layer are collectively referred to as an electrode.

In order to prevent the leakage of a supplied fuel gas and the mixing of two types of fuel gases, a gas sealing member or a gasket is disposed around the electrode in such a manner as to sandwich the ion-exchange membrane. The gas sealing member, gasket, electrode, and ion-exchange membrane are assembled in an integrated manner beforehand such that a membrane-electrode assembly (MEA) is prepared.

On the outside of the MEA, an electrically conductive and airtight separator is disposed so as to mechanically fix the MEA and electrically connect it to adjacent MEAs in series. A portion of the separator that comes into contact with the MEA is formed with a gas channel for supplying a reaction gas to the electrode surface and to carry produced gas or excess gas away. While the gas channel can be provided separately from the separator, it is generally formed by providing a groove in the surface of the separator. Such structure, consisting of an MEA fixed by means of a pair of separators, is used as a single cell, which is a basic unit of a fuel cell.

By connecting a plurality of such single cells in series and arranging a manifold, which is a piping jig for the supply of fuel gas, a fuel cell is constructed.

In general, the above gas diffusion layer is prepared with the use of a substrate, such as carbon paper or carbon cloth, and powder of fluorine resin, silicon, carbon, or the like.

JP Patent Publication (Kokai) No. 8-236123 A (1996) discloses a fuel cell electrode and a method for producing the same. The fuel cell has a catalyst layer comprising catalyst particles, a polytetrafluoroethylene group polymer, and a polymer electrolyte. The catalyst layer is obtained by adding a thickening agent (and a nonionic surfactant) to a liquid mixture containing catalyst particles and a dispersion of polytetrafluoroethylene group polymer, carrying out a thermal treatment, and coating the resultant with a polymer electrolyte. The invention is intended to significantly improve formability of the catalyst layer without causing cell performance deterioration, to effectively activate a three dimensional reaction site in a polymer electrolyte, to uniformize the thus obtained catalyst layer, and to enhance the catalyst utilization, thereby improving electrode characteristics.

As described in JP Patent Publication (Kokai) No. 8-236123 A (1996), in the case of the use of a fuel cell electrode having a catalyst layer that has been obtained by adding a thickening agent (and a nonionic surfactant) to a liquid mixture containing catalyst particles and a dispersion of polytetrafluoroethylene group polymer (PTFE), carrying out a thermal treatment, and coating the resultant with a polymer electrolyte (Nafion: trade name), voltage drop occurs in a material transport region (high current density region), which is problematic.

The possible reason for the above problem is described below.

Polytetrafluoroethylene (PTFE) is characterized in that:

(1) it is a typical non-polar polymer having extremely low cohesive energy density; and
(2) it has a very high degree of crystallinity of 95% or more.

PTFE is characterized as per (1) and (2) above. In other words, PTFE has non-polar C—F bonds and a high binding energy of 114 kcal/mol so that it is highly crystalline. Thus, PTFE is highly drug-resistant and has a low critical surface tension (index of dispersion of a solvent on a polymer surface). Therefore, a solvent does not disperse on PTFE (polymer) surfaces and remain in the form of droplets thereon. In the case of the electrode obtained by Patent Document 1, a high degree of wettability of a polymer electrolyte (Nafion: trade name) on PTFE results in the obvious delamination of the catalyst layer and an increase in the amount of diffusing gas that does not react with the catalyst. Accordingly, it is considered that significant voltage drop occurs in a material transport region (high current density region).

### DISCLOSURE OF THE INVENTION

It is an objective of the present invention to provide: a fuel cell electrode in which the adhesivity between a gas diffusion layer made of carbon paper or carbon cloth and an electrode catalyst layer comprising catalyst particles and a polymer electrolyte is improved and delamination of or crack generation in an electrode catalyst layer does not occur; a membrane-electrode assembly (MEA) comprising the fuel cell electrode; and a solid polymer fuel cell comprising the membrane-electrode assembly.

The present inventors have found that the above objective is achieved with a laminated structure in which a specific binder layer (buffer layer) is provided between a gas diffusion layer and an electrode catalyst layer. This has led to the completion of the present invention.

Specifically, in a first aspect, the present invention relates to a fuel cell electrode in which a binder layer (buffer layer) containing a thickening agent is provided on a gas diffusion layer and an electrode catalyst layer containing catalyst particles and a polymer electrolyte is laminated on the binder layer (buffer layer).

In accordance with the present invention, a binder is a cellulose derivative. Preferred examples of a cellulose derivative include at least one selected from the group consisting of nitrocellulose, trimethylcellulose, alkylcellulose, ethylcellulose, benzylcellulose, carboxymethylcellulose (CMC), and methylcellulose (MC). In particular, carboxymethylcellulose (CMC) is preferable in terms of adhesivity to carbon paper and/or carbon cloth used for a representative gas diffusion layer.

It is preferable to add, as an optional component, a thickening agent to a binder layer (buffer layer), in addition to a binder. Preferred examples of a thickening agent include at least one selected from the group consisting of styrene-butadiene rubber (SBR) latex, a polytetrafluoroethylene (PTFE) aqueous dispersion, polyolefins, polyimide, PTFE powder, fluororubber, thermosetting resin, polyurethane, polyethyleneoxide (PEO), polyaniline (PAN), polyvinylidenefluoride (PVdF), polyhexafluoropropylene (PHFP), polyvinyl ether/methyl methacrylate (PVE/MMA), casein, starch, ammonium alginate, polyvinyl alcohol (PVA), and ammonium polyacrylate.

In accordance with the invention, for the gas diffusion layer, gas diffusion layers used in the filed of solid polymer fuel cells can be widely used. Preferred examples thereof include carbon paper and carbon cloth.

In a second aspect, the present invention relates to a method for producing the above fuel cell electrode, comprising the steps of: applying a binder layer (buffer layer) containing a thickening agent to a gas diffusion layer; and applying an electrode catalyst layer containing catalyst particles and a polymer electrolyte to the binder layer (buffer layer).

According to the method for producing the fuel cell electrode of the present invention, the binder, the thickening agent, and the gas diffusion layer used are as described above.

In a third aspect, the present invention relates to a membrane-electrode assembly (MEA) in which a proton exchange membrane, an electrode catalyst layer, and a gas diffusion layer are laminated, wherein a binder layer (buffer layer) containing a thickening agent is provided between the electrode catalyst layer and the gas diffusion layer.

According to the membrane-electrode assembly (MEA) of the present invention, the binder, the thickening agent, and the gas diffusion layer used are as described above.

In a forth aspect, the present invention relates to a method for producing the above membrane-electrode assembly (MEA) in which a proton exchange membrane, an electrode catalyst layer, and a gas diffusion layer are laminated, such method comprising the steps of: applying a binder layer (buffer layer) containing a thickening agent to a gas diffusion layer; and applying an electrode catalyst layer containing catalyst particles and a polymer electrolyte to the binder layer (buffer layer).

According to the method for producing the membrane-electrode assembly (MEA) of the present invention, the binder, the thickening agent, and the gas diffusion layer used are as described above.

In a fifth aspect, the present invention relates to a solid polymer fuel cell in which the above membrane-electrode assembly (MEA) is used.

According to the fuel cell electrode and the membrane-electrode assembly (MEA) of the present invention, (1): the binder layer (buffer layer) has improved bonding capacity with the gas diffusion layer so that delamination is reduced, and (2): the binder layer (buffer layer) has improved bonding capacity with the electrode catalyst layer so that crack generation is suppressed. Specifically, a water-soluble binder, such as carboxymethylcellulose (CMC), used for the binder layer (buffer layer) has high adhesivity to carbon paper and/or carbon cloth used for the gas diffusion layer, resulting in the improvement of bonding strength. Likewise, both a water-soluble binder, such as carboxymethylcellulose (CMC), used for the binder layer (buffer layer) and a polymer electrolyte, such as Nafion (trade name), contained in the electrode catalyst layer are watersoluble and have high adhesivity so that they are integrated on the bonded surface so as to bond to each other.

Further, according to the fuel cell electrode of the present invention, a laminated structure (an electrode catalyst layer/a binder layer (buffer layer)/a gas diffusion layer) is used. Thus, a fuel cell comprising the membrane-electrode assembly (MEA) prepared with the fuel cell electrode has high bonding strength and thus delamination of or crack generation in the electrode catalyst layer does not occur during operation. Accordingly, fuel cell performance can be maintained.

### BRIEF DESCRIPTION OF THE DRAWINGS

FIG. 1 schematically shows the laminated structure of the fuel cell electrode of the present invention.

FIG. 2 is a schematic diagram of the conductivity when delamination occurs between a gas diffusion layer and an electrode catalyst layer or when cracks are generated in an electrode catalyst layer.

FIG. 3 schematically shows factors related to cell voltage drop in a fuel cell.

FIG. 4 shows an SEM image of a cross section of the Example.

FIG. 5 shows an SEM image of a cross section of the Comparative example.

### BEST MODE FOR CARRYING OUT THE INVENTION

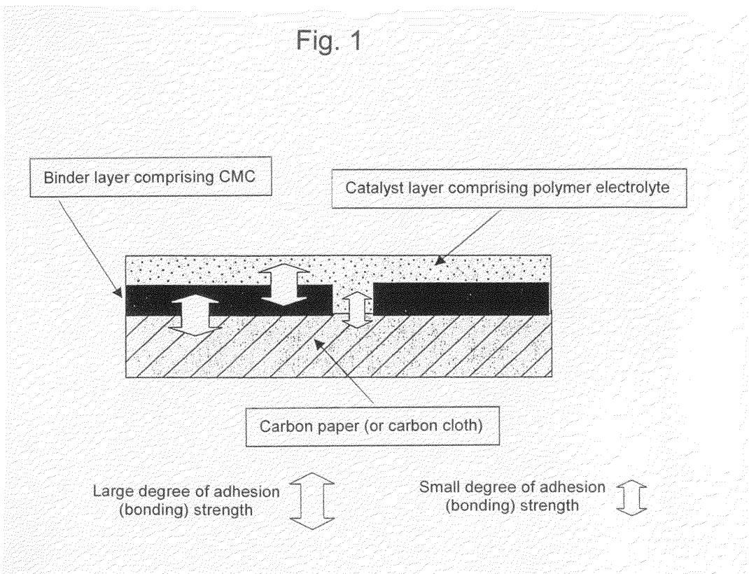

FIG. 1 schematically shows a laminated structure of the fuel cell electrode of the present invention. FIG. 1 shows a case in which carboxymethylcellulose (CMC) or the like is used for a binder layer (buffer layer), carbon paper and/or carbon cloth is/are used for a gas diffusion layer, and an electrode catalyst layer contains a polymer electrolyte such as Nafion (trade name).

As shown in FIG. 1, the adhesivity of the bonding interface on which a gas diffusion layer directly comes into contact with an electrode catalyst layer is low. Meanwhile, when a binder layer (buffer layer) containing carboxymethylcellulose (CMC) is introduced between a gas diffusion layer and an electrode catalyst layer, bonding strength is improved due to the high adhesivity between carboxymethylcellulose (CMC) and carbon paper and/or carbon cloth. Likewise, both carboxymethylcellulose (CMC) and a polymer electrolyte such as Nafion (trade name) are watersoluble and have high adhesivity so that they are integrated on the bonded surface so as to bond to each other.

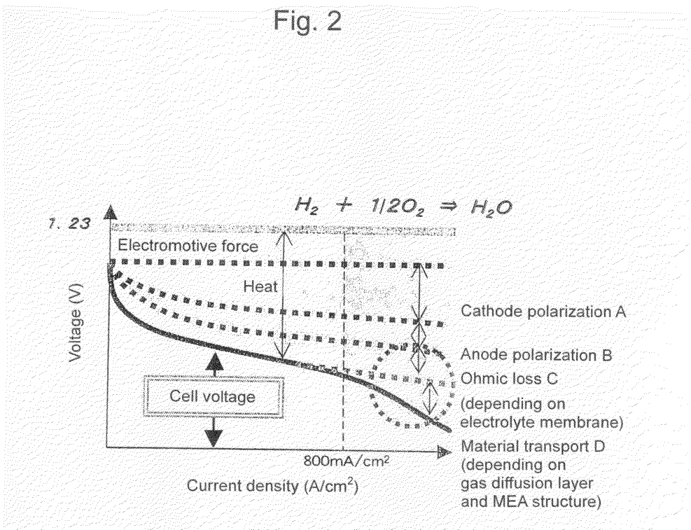

FIG. 2 is a schematic diagram of the conductivity when delamination occurs between a gas diffusion layer and an electrode catalyst layer or when cracks are generated in an electrode catalyst layer. As shown in FIG. 2, if delamination of or crack generation in a catalyst layer formed on carbon paper (or carbon cloth) occurs, it is assumed that diffusion polarization would occur upon material transport and fuel would be wasted due to leakage of fuel through an electrolyte membrane, which is referred to as crossover. This would result in voltage drop, particularly at a high current density.

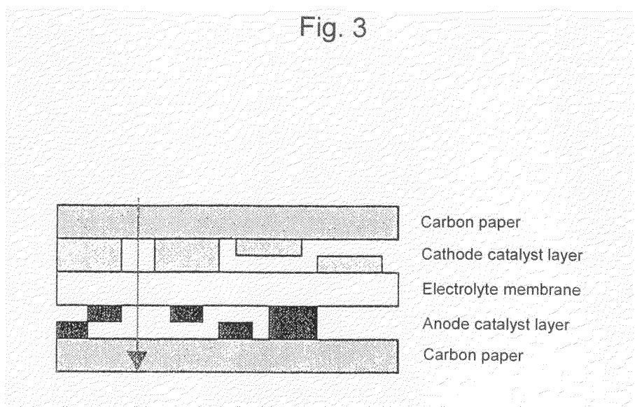

FIG. 3 schematically shows factors related to cell voltage drop in a fuel cell. As shown in FIG. 3, cell voltage drop from electromotive force is caused by cathode polarization A, anode polarization B, and ohmic loss C (depending upon an electrolyte membrane). At a current density of approximately 800 mA/cm² or more, material transport D depending on the gas diffusion layer or MEA structure is induced. Thus, cell voltage drops sharply.

Hereinafter, the present invention will be described in detail.

As the gas diffusion layer (electrode substrate) used in the present invention, gas diffusion layers generally used for fuel cells are used without particular limitation. For instance, a porous conductive sheet mainly consisting of a conductive substance is used. Examples of such conductive substance include a sintered product of polyacrylonitrile, Mesophase pitch group carbon fiber, a sintered product of perylene, a sintered product of pitch, carbon material such as graphite or expanded graphite, stainless steel, molybdenum, and titanium. A conductive substance may be in a fibrous form or in a particulate form, but it is not particularly limited thereto. However, in the case in which such substance is used for an electrochemical apparatus such as a fuel cell in which a gas is used as an electrode active material, an inorganic conductive fibrous substance (inorganic conductive fiber) such as, in particular, carbon fiber, is preferable in terms of gas permeability. As a porous conductive sheet comprising inorganic conductive fiber, either woven fabric or nonwoven fabric may be used in terms of structure. The porous conductive sheet of the present invention is not particularly limited. However, in a preferred embodiment, it is possible to add, as an adjuvant, conductive particles of carbon black or the like and conductive fiber such as carbon fiber to the porous conductive sheet in order to improve conductivity.

Examples of the gas diffusion layer include, in addition to the above gas diffusion layer, carbon fiber paper obtained by binding short carbon fibers oriented in random directions on a substantially two-dimensional plane with a polymer substance. In addition, by binding short carbon fibers with a polymer substance, carbon fiber paper becomes resistant to compression or tension so as to obtain improved strength and handling properties. Thus, it becomes possible to prevent short carbon fibers from becoming detached from carbon fiber paper or becoming oriented in the thickness direction of carbon fiber paper.

In a solid polymer fuel cell, water is generated as an electrode reaction product or water that has permeated through an electrolyte is generated in a cathode (air electrode or oxygen electrode). In addition, in an anode (fuel electrode), fuel is humidified and then supplied in order to prevent drying of a proton exchange membrane. Since the supply of an electrode reactant is interrupted by dew formation or water accumulation due to humidification and by swelling of polymer substances in the presence of water, it is preferable that a polymer substance have a low water absorption rate.

The content of a polymer substance in the gas diffusion layer is preferably from 0.1% to 50% by weight. In order to reduce the electric resistance of carbon fiber paper, it is preferable that the content of a polymer substance be low. However, at less than 0.1% by weight, the gas diffusion layer cannot have strength sufficient to resist handling, resulting in detachment of many short carbon fibers. On the other hand, at more than 50% by weight, the electric resistance of carbon fiber paper increases, which is problematic. More preferably, such content is from 1% to 30% by weight.

Examples of carbon fiber include polyacrylonitrile (PAN) group carbon fiber, phenol group carbon fiber, pitch group carbon fiber, and rayon group carbon fiber. Among them, PAN group carbon fiber is preferable.

Preferably, the gas diffusion layer used for the present invention comprises a porous conductive sheet in which conductive particles having flexibility are arranged in a sheet form. As a result, it becomes possible to provide a cost-effective gas diffusion layer having a low electric resistance, in which detachment of components rarely occurs and which seldom becomes broken upon application of mechanical force. In particular, the above objective can be achieved with the use of expanded graphite particles as conductive particles having flexibility. The term “expanded graphite particles” used herein refers to graphite particles obtained by preparing an intercalation compound of graphite particles with the use of sulfuric acid, nitric acid, or the like and causing the compound to be expanded by quick heating.

In a preferred embodiment, the porous conductive sheet used for the gas diffusion layer of the present invention comprises, in addition to conductive fine particles having flexibility, other conductive particles or conductive fibers. However, when both conductive fiber and conductive particles are made of inorganic materials, an electrode substrate that is superior in heat resistance, oxidation resistance, and elution resistance can be obtained.

A proton exchange membrane used for the present invention is not particularly limited. Specifically, it contains, as a proton exchange group, a sulfonic group, a carboxylic group, and a phosphoric group, for example. Among them, a sulfonic group is preferably used in terms of exhibition of fuel cell performance.

Preferred examples of such proton exchange membrane that can be used include a hydrocarbon group proton exchange membrane comprising a styrene-divinylbenzene copolymer or the like and a perfluoro group proton exchange membrane comprising a fluoroalkyl copolymer having fluoroalkyl ether side chains and perfluoroalkyl main chains. These are adequately selected in accordance with the application of and environment for a fuel cell. However, a perfluoro group proton exchange membrane is preferable in terms of fuel cell life. In addition, as a hydrocarbon proton exchange membrane, a partially fluorinated film subjected to partial fluorine atom substitution is also preferably used. Examples of a perfluoro group proton exchange membrane include Nafion (trade name) by DuPont, Aciplex (trade name) by Asahi Kasei Corporation, Flemion (trade name) by Asahi Glass Co., Ltd, and GORE-SELECT (trade name) by Japan Gore-Tex Inc. Examples of a partially fluorinated film include a film obtained by introducing a sulfonic group into trifluorostyrenesulfonic acid polymer, polyvinylidene difluoride, or the like.

Examples of a proton exchange membrane that can be used further include, in addition to a membrane comprising a single type of polymer, a membrane comprising a copolymer or blend polymer consisting of two or more types of polymers, a composite membrane obtained by bonding two or more types of membranes, and a membrane obtained by reinforcing a proton exchange membrane with nonwoven fabric, porous film, or the like.

The electrode catalyst layer of the present invention comprises at least a catalyst or a catalyst-supporting medium. (For instance, catalyst-supporting carbon is preferable. Hereinafter, catalyst-supporting carbon is explained as an example, although the present invention is not limited thereto.) For instance, the electrode catalyst layer of the present invention comprises, but is not particularly limited to, a polymer that is formed into a catalyst layer in which binding between catalyst-supporting carbon and catalyst-supporting carbon, catalyst-supporting carbon and an electrode substrate, or catalyst-supporting carbon and a proton exchange membrane is achieved.

A catalyst contained in catalyst-supporting carbon is not particularly limited. However, examples of such catalyst that can be preferably used include noble metal catalysts such as platinum, gold, palladium, ruthenium, and iridium, because they have low activation overvoltages during a catalytic reaction. In addition, catalyst-supporting carbon may contain, for example, an alloy or mixture of such noble metal catalysts, which comprises two or more elements.

Preferred examples of carbon that constitutes catalyst-supporting carbon include, but are not particularly limited to, carbon blacks such as oil-furnace black, channel black, lamp black, thermal black, and acetylene black in view of electronic conductivity and the size of specific surface area. Examples of oil-furnace black include VULCAN XC-72, VULCAN P, BLACK PEARLS 880, BLACK PEARLS 1100, BLACK PEARLS 1300, BLACK PEARLS 2000, and REGAL 400 by Cabot Corporation, ketchen black EC by LION Corporation, and #3150 and #3250 by Mitsubishi Chemical Corporation. Examples of acetylene black include DENKA BLACK by Denki Kagaku Kogyo Kabushiki Kaisha.

A polymer contained in an electrode catalyst layer is not particularly limited. However, a polymer that does not deteriorate in an oxidation-reduction atmosphere in a fuel cell is preferable. Such polymer may be a polymer comprising fluorine atoms. Examples of such polymer that can be used include, but are not particularly limited to, polyvinyl fluoride (PVF), polyvinylidene difluoride (PVDF), polyhexafluoropropylene (FEP), polytetrafluoroethylene, polyperfluoroalkylvinyl ether (PFA), a copolymer thereof, and a copolymer or blend polymer comprising a monomer unit of any of the above examples and another monomer such as an ethylene or styrene monomer.

As a polymer contained in an electrode catalyst layer, a polymer having a proton exchange group is also preferable in view of the improvement of proton conductivity in the electrode catalyst layer. Examples of a proton exchange group contained in such polymer include, but are not particularly limited to, a sulfonic group, a carboxylic group, and a phosphoric group. In addition, a polymer having such proton exchange group is selected without particular limitation. However, a fluoroalkyl copolymer having a fluoroalkyl ether side chain comprising a proton exchange group is preferably used. Preferred examples thereof include Nafion (trade name) by DuPont. Further, the above polymer containing fluorine atoms and having a proton exchange group, another polymer such as ethylene or styrene polymer, and a copolymer or blend polymer thereof may be used.

As a polymer contained in an electrode catalyst layer, it is also preferable to use a polymer obtained by polymerizing or blending the above polymer containing fluorine atoms and a polymer having a proton exchange group. In view of electrode performance, it is particularly preferable to blend polyvinylidene difluoride, a poly (hexafluoropropylene-vinylidene difluoride) copolymer, or the like with a polymer such as Nafion (trade name) comprising a proton exchange group with a fluoroalkyl ether side chain and a fluoroalkyl main chain.

The main components of an electrode catalyst layer are preferably catalyst-supporting carbon and a polymer. The ratio thereof is adequately determined based on required electrode characteristics without particular limitation. However, the weight ratio of catalyst-supporting carbon:a polymer is preferably from 5:95 to 95:5. In particular, when an electrode catalyst layer is used for a solid polymer fuel cell, the weight ratio of catalyst-supporting carbon/polymer is preferably from 40:60 to 85:15.

In addition to the above carbon such as catalyst-supporting carbon, it is also preferable to add a variety of conductive agents to an electrode catalyst layer in order to improve electronic conductivity. Examples of such conductive agent include, but are not particularly limited to, a variety of graphitic carbon materials and carbonaceous materials, metals, and semiconductors, in addition to carbon black similar to the above carbon used for catalyst-supporting carbon. Examples of such carbon materials include, in addition to the above carbon black, artificial graphites and carbons obtained from organic compounds such as naturally occurring graphite, pitch, coke, polyacrylonitrile, phenol resin, and furan resin. Such carbon materials can be used not only in a particulate form but also in a fibrous form. Further, it is also possible to use carbon materials obtained by post-treatment processing of the above carbon materials. The contents of the above conductive agents added are preferably 1% to 80% by weight and more preferably 5% to 50% by weight relative to an electrode catalyst layer.

According to the present invention, a method for applying a binder layer and an electrode catalyst layer to a gas diffusion layer is not particularly limited. A binder layer in the form of kneaded paste comprising a variety of watersoluble binders may be directly added to or formed on a gas diffusion layer by a method of large-brush painting, small-brush painting, bar coating, knife coating, screen printing, spray coating, or the like. Alternatively, a binder layer may be temporarily formed on another substrate (transfer substrate) and then transferred to a gas diffusion layer. Examples of such transfer substrate that can be used include a polytetrafluoroethylene (PTFE) sheet and a glass plate or metal plate, the surface of which has been treated with a fluorine or silicon group release agent.

Likewise, an electrode catalyst layer in the form of kneaded paste comprising catalyst-supporting carbon and a polymer to be contained in an electrode catalyst layer may be directly added to or formed on a binder layer by a method of large-brush painting, small-brush painting, bar coating, knife coating, screen printing, spray coating, or the like. Alternatively, an electrode catalyst layer may be temporarily formed on another substrate (transfer substrate) and then transferred to a binder layer. Examples of such transfer substrate that can be used include a polytetrafluoroethylene (PTFE) sheet and a glass plate or metal plate, the surface of which has been treated with a fluorine or silicon group release agent.

According to the present invention, the pressure applied upon bonding of a fuel cell electrode or a membrane-electrode assembly is preferably 1 to 10 MPa and more preferably 2 to 10 MPa. When the pressure applied is 1 MPa or less, the electrode catalyst layer/binder/gas diffusion layer bonding is not sufficiently carried out, resulting in high ionic resistance or high electronic resistance at each interface, which is not preferable. In addition, when the pressure applied is 10 MPa or more, an electrode catalyst layer becomes broken and thus the diffusivity of a reaction gas in the electrode catalyst layer is suppressed, which is not preferable.

In addition, the treatment time for heating and pressurization may differ depending upon temperature or pressure. In most cases, the higher the temperature and the pressure, the shorter the treatment time. The treatment time is preferably 10 minutes or longer, more preferably 30 minutes or longer, and further preferably 60 minutes or longer.

The fuel cell electrode and the membrane-electrode assembly of the present invention can be applied to a variety of electrochemical apparatuses. In particular, they can be preferably applied to fuel cells. Among fuel cells, they can be preferably applied to solid polymer fuel cells. There are fuel cells in which hydrogen is used as fuel and those in which a hydrocarbon such as methanol is used as fuel. However, the present invention can be used without particular limitation.

Possible applications of fuel cells in which the fuel cell electrode and/or the membrane-electrode assembly of the present invention are used are not particularly limited. However, such fuel cells are preferably used as electricity supply sources for automobiles in view of useful applications of solid polymer fuel cells.

### EXAMPLES

The present invention is hereafter described in greater detail with reference to the following examples, although the technical scope of the present invention is not limited thereto.

### Examples

A catalyst in an amount of 0.40 g (C: 78 wt %, N:C (Nafion:carbon): 0.75:1) and an electrolyte (Nafion) (10 wt %, 2.34 g) were added to a solvent comprising water (4.68 g), ethanol (2.34 g), and propylene glycol (1.56 g), followed by pulverization for 30 seconds×6 times and then ultrasound dispersion for 30 minutes×3 times. Thus, an ink was prepared. The prepared ink was applied by a squeegee 10 to 12 times on carbon paper having a binder layer (buffer layer) comprising carboxymethylcellulose (CMC) and then air-dried. After hot pressing, the carbon paper was dried at 80° C. under a nitrogen atmosphere and further vacuum-dried.

Kneading procedures are as follows. An active material comprising a catalyst/a carrier was weighed and placed in a biaxial pot. CMC was weighed and placed in the biaxial pot. Powder mixing is carried out with a biaxial kneader. A solvent is placed in the pot (1^{st} time), followed by kneading with a biaxial kneader. A solvent is placed in the pot (2^{nd} time), followed by kneading with a biaxial kneader. SBR that serves as a binder adjuvant is placed in the pot, followed by kneading with a biaxial kneader. Deforming is carried out. Then, the viscosity is measured. The particle gauge was measured.

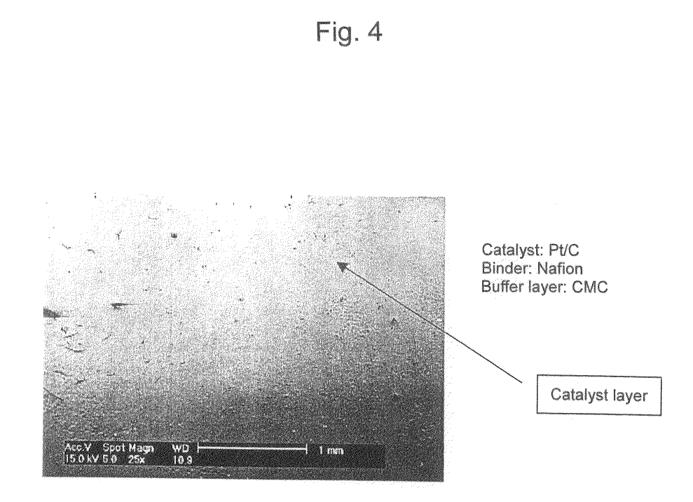

FIG. 4 shows an SEM image of a cross section of a catalyst layer. In this Example, the catalyst layer had few cracks. Thus, it is understood that delamination of the catalyst layer from carbon cloth rarely occurred.

### Comparative Example

The Comparative example was carried out as with the Example, except that carboxymethylcellulose (CMC) was not used for a binder layer (buffer layer).

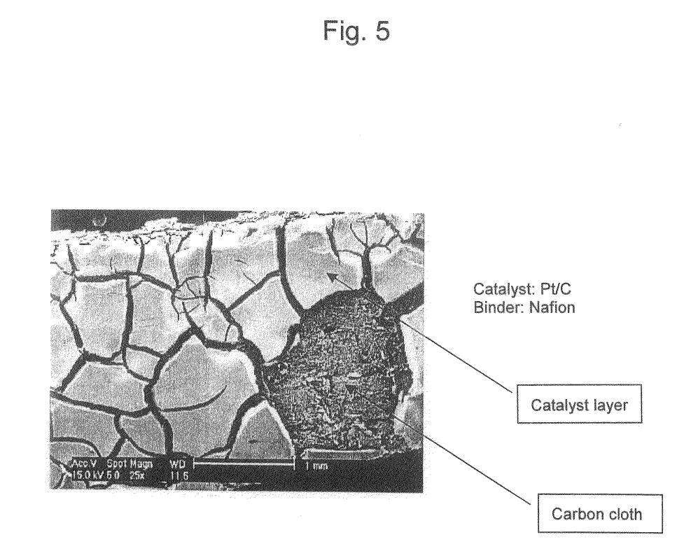

FIG. 5 shows an SEM image of a cross section of a catalyst layer. In this Comparative example, the catalyst layer had cracks. Thus, it is understood that delamination of the catalyst layer from the carbon cloth occurred.

With the use of fuel cell electrodes obtained in the Example and the Comparative example, membrane-electrode assemblies (MEAs) were prepared. In the case of a fuel cell in which the membrane-electrode assembly (MEA) of the Example was used, the bonding strength between a gas diffusion layer and an electrode catalyst layer was sufficient so that performance degradation in the fuel cell during operation was suppressed.

### INDUSTRIAL APPLICABILITY

According to the fuel cell electrode and the membrane-electrode assembly (MEA) of the present invention, (1): the binder layer (buffer layer) has improved bonding capacity with the gas diffusion layer so that delamination is reduced, and (2): the binder layer (buffer layer) has improved bonding capacity with the electrode catalyst layer so that crack generation is suppressed. The bonding capacity between an electrode catalyst layer and a gas diffusion layer was improved and no cracks were generated in the electrode catalyst layer. Accordingly, it was possible to improve the electric generation property, and in particular, the electric generation property in the high current density region, of the fuel cell. Thus, the present invention contributes to the practical widespread use of fuel cells.

1. A fuel cell electrode in which a binder layer (buffer layer) containing a thickening agent selected from cellulose derivatives is provided on a gas diffusion layer and an electrode catalyst layer containing catalyst particles and a polymer electrolyte is laminated on the binder layer (buffer layer).

2. The fuel cell electrode according to claim 1, wherein the binder is a cellulose derivative that is at least one selected from the group consisting of nitrocellulose, trimethylcellulose, alkylcellulose, ethylcellulose, benzylcellulose, carboxymethylcellulose (CMC), and methylcellulose (MC).

3. The fuel cell electrode according to claim 1 or 2, wherein the gas diffusion layer is made of carbon paper and/or carbon cloth.

4. A method for producing a fuel cell electrode, comprising the steps of:
applying a binder layer (buffer layer) containing a thickening agent to a gas diffusion layer and;
applying an electrode catalyst layer containing catalyst particles and a polymer electrolyte to the binder layer (buffer layer).

5. The method for producing a fuel cell electrode according to claim 4, wherein the binder is a cellulose derivative that is at least one selected from the group consisting of nitrocellulose, trimethylcellulose, alkylcellulose, ethylcellulose, benzylcellulose, carboxymethylcellulose (CMC), and methylcellulose (MC).

6. The method for producing a fuel cell electrode according to claim 4 or 5, wherein the gas diffusion layer is made of carbon paper and/or carbon cloth.

7. A membrane-electrode assembly in which a proton exchange membrane, an electrode catalyst layer, and a gas diffusion layer are laminated, wherein a binder layer (buffer layer) containing a thickening agent is provided between the electrode catalyst layer and the gas diffusion layer.

8. The membrane-electrode assembly according to claim 7, wherein the binder is a cellulose derivative that is at least one selected from the group consisting of nitrocellulose, trimethylcellulose, alkylcellulose, ethylcellulose, benzylcellulose, carboxymethylcellulose (CMC), and methylcellulose (MC).

9. The membrane-electrode assembly according to claim 7 or 8, wherein the gas diffusion layer is made of carbon paper and/or carbon cloth.

10. A method for producing the above membrane-electrode assembly (MEA) in which a proton exchange membrane, an electrode catalyst layer, and a gas diffusion layer are laminated, comprising the steps of:
applying a binder layer (buffer layer) containing a thickening agent to a gas diffusion layer; and
applying an electrode catalyst layer comprising catalyst particles and a polymer electrolyte to the binder layer (buffer layer).

11. The method for producing a membrane-electrode assembly according to claim 10, wherein the binder is a cellulose derivative that is at least one selected from the group consisting of nitrocellulose, trimethylcellulose, alkylcellulose, ethylcellulose, benzylcellulose, carboxymethylcellulose (CMC), and methylcellulose (MC).

12. The method for producing a membrane-electrode assembly according to claim 10 or 11, wherein the gas diffusion layer is made of carbon paper and/or carbon cloth.

13. A solid polymer fuel cell in which the membrane-electrode assembly according to any one of claims 7 to 9 is used.
